(19) United States
(12) Patent Application Publication
(10) Pub. No.: US 2021/0241235 A1
(43) Pub. Date: Aug. 5, 2021

(54) SYSTEM FOR SCHEDULING ACCOUNT CONTACT

(71) Applicant: Attunely Inc., Seattle, WA (US)

(72) Inventors: Ryan Kosai, Seattle, WA (US); Adam J. Profitt, Seattle, WA (US); Carl Toews, Seattle, WA (US)

(73) Assignee: Attunely Inc., Seattle, WA (US)

(21) Appl. No.: 17/164,664

(22) Filed: Feb. 1, 2021

Related U.S. Application Data
(60) Provisional application No. 62/968,756, filed on Jan. 31, 2020.

(51) Int. Cl. G06Q 10/10; G06N 7/00; G06N 20/00; H04M 3/51

(52) U.S. Cl. CPC G06Q 10/1093; G06N 7/005; H04M 2203/402; H04M 3/51; G06N 20/00

(57) ABSTRACT

Disclosed is a system to determine a first contact probability for each of a plurality of time slots for each of a plurality of first accounts using a trained machine learning model based on a first set of account information and first contact attempt logs, determine a first prioritization for each of a plurality of first accounts based on a second set of account information, and generate a contact schedule based on the first contact probability for each of the plurality of time slots and the first prioritization. The trained machine learning model is trained based on training accounts.

### CROSS-REFERENCE TO RELATED PATENTS

This patent claims the benefit of and priority to U.S. Provisional Patent Application Ser. No. 62/968,756, filed on Jan. 31, 2021, titled “System For Scheduling Account Contact,” the disclosure of which is hereby incorporated by reference for all purposes.

### BACKGROUND

If a collections agency is able to make contact with an account holder (e.g., a debtor), the probability of liquidation or rehabilitation of the account goes up significantly. Scheduling and calendar devices and applications may be used to organize time and resources for attempting to make contact with the account holder. Different systems exist to schedule resources in the hopes of improving probability of contact. However, in situations where there is limited information it can be difficult to schedule limited resources, such as worker time and system bandwidth, in an effective manner. Deploying resources—especially human capital such as call center employees—on a less than ideal schedule can result in waste.

A superior system for scheduling account contact has eluded those skilled in the art.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In many circumstances (such as debt collection, sales, fundraising, and the like) a person responsible for an account (an “account responsible”) is contacted without a prearranged appointment or knowledge of availability. Often is the case that insufficient information is known about the account responsible to identify when the account responsible will be available to discuss the account or if the account responsible will even respond to contact attempts.

Described herein is a system which uses machine learning models trained using available information to predict a contact probability for contacting an account responsible during different time slots. The system prioritizes the accounts and uses the prioritization and the contact probability to generate a contact schedule. The schedule may be generated one time slot at a time, or several time slots at a time (such as for a day or for a week). Other embodiments will also become apparent to those skilled in the art from the teachings and examples provided herein.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 illustrates one example system in accordance with the teachings of the present disclosure.

FIG. 2 is a functional block diagram generally illustrating a contact system to create a preferential schedule of outbound communication from one or more senders in accordance with the teachings of the present disclosure.

FIG. 3 is a flow diagram generally illustrating processing of data to obtain a contact schedule in accordance with the teachings of the present disclosure.

FIG. 4 is a flow diagram generally illustrating a process to train a machine learning model in accordance with the teachings of the present disclosure.

FIG. 5 is a flow diagram generally illustrating a method of generating a contact schedule and contacting first accounts in accordance with the teachings of the present disclosure.

FIG. 6 is a flow diagram generally illustrating a greedy scheduling approach in accordance with one embodiment of the disclosure.

### DETAILED DESCRIPTION

While illustrative embodiments will be illustrated and described, it will be appreciated that various changes can be made therein without departing from the spirit and scope of the disclosures.

Generally stated, the present disclosure is directed at a system to create a preferential schedule of outbound communication attempts to an account representative. Each account in a list of subject accounts is prioritized based on a configurable goal. The accounts are then each assigned to time windows within which actions may occur. The accounts are assigned to the time windows based at least in part on the priorities of the accounts and also based at least in part on an estimated likelihood that a future action will result in a successful outcome. A contact schedule may be generated based on the assignments.

Before proceeding, one illustrative computing system is described which may be used to implement many embodiments of the disclosure. The following illustrative computing system is provided to demonstrate one particular apparatus that may be specially configured to implement embodiments. Other computing systems may also be adapted for use in various preferred embodiments.

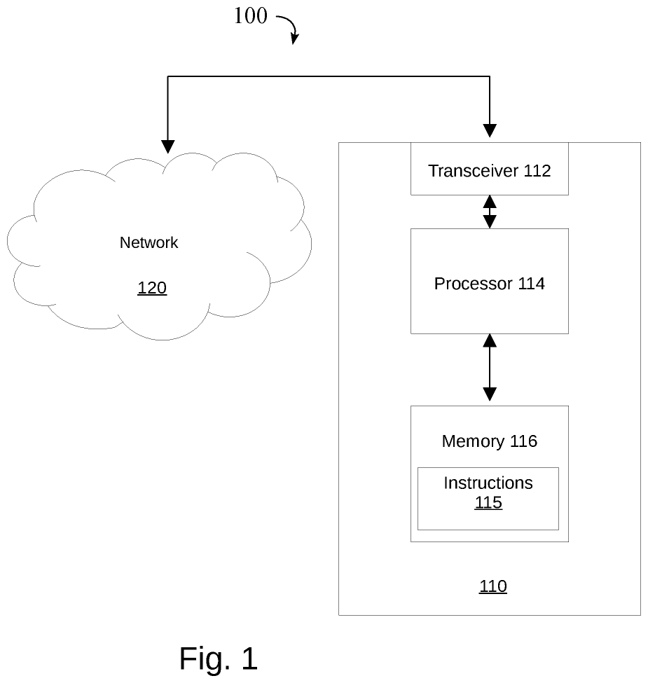

FIG. 1 illustrates one illustrative computing system 100 in which embodiments may be implemented in accordance with the teachings of the present disclosure. The system 100 represents one example computing environment in which preferred embodiments of the present disclosure may be implemented. It will be appreciated that other embodiments may be implemented in alternative computing environments without deviating from the spirit and scope of the disclosure.

The system 100 includes a processing device 110 connected to a network 120. In one basic configuration, the Processing device 110 may include a transceiver 112, a processor 114, and a memory 116. The transceiver 112 may connect the processing device 110 to the network 120. The network 120 may include any number of devices, servers, or other communication equipment. The processing device 110 may be implemented as a computer, a server, a mobile computing device, or the like. The memory 116 may store computer readable instructions 115 which when executed by the processor 114 cause the processing device 110 to perform operations in accordance with the teachings of the present disclosure. The processor 114 may be configured to execute the computer readable instructions 115. The memory 116 may be volatile and/or non-volatile. The processor 114 may be a CPU or other processing hardware.

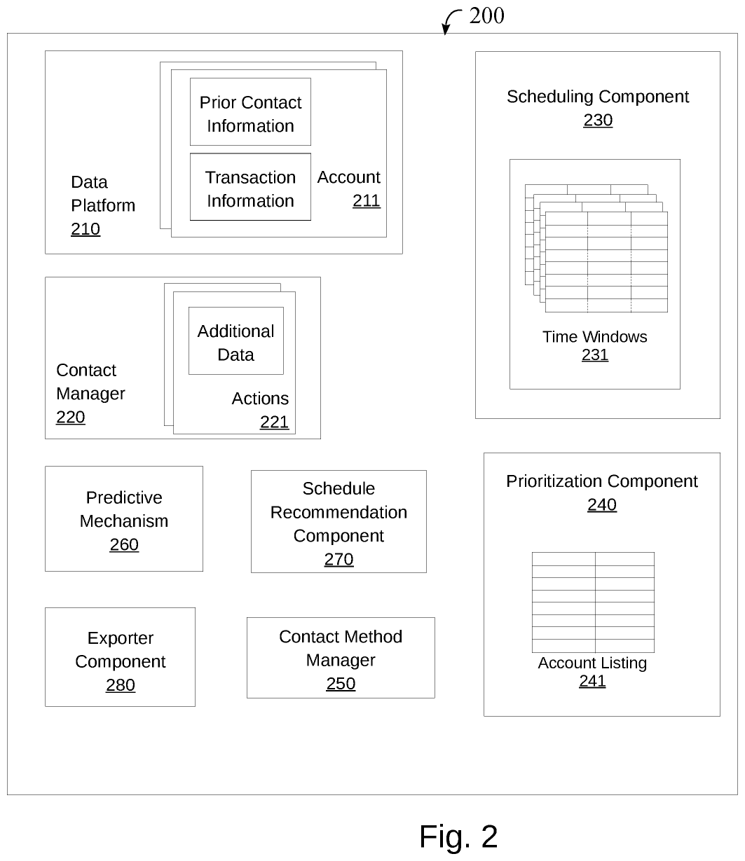

Turning now to FIG. 2, illustrated is an illustrative contact system 200 to create a preferential schedule of outbound communication from one or more senders. In various preferred embodiments, the illustrative contact system includes one or more components which cooperate to accomplish the various tasks and functions described below. The contact system 200, each of its constituent components, or any combination thereof may be implemented using various incarnations of the illustrative computing system 100 described above.

The contact system 200 may include a data platform 210 to intake and manage data regarding one or more individual accounts 211. An “account” 211 is a data structure that may be conceptually associated with one or more individuals who collectively receive or process communications regarding financial transactions (singularly or collectively, the “account representative”). In one illustrative example, an “account” 211 is associated with an account representative and represents information related to financial transactions for which the account representative is responsible.

An account 211 may also include additional information about the timing, content, and result of previously attempted inbound or outbound communications with the account representative (“prior contact information”). For example, in one preferred embodiment, an account 211 may contain data about previous phone calls, letters, e-mails, or SMS messages.

An account 211 may also contain information related to previous, current, or future transactions associated with the individuals (“transaction information”). In one preferred embodiment, an account 211 includes information about one or more specific delinquent debts. In another, the account 211 contains information related to an ongoing series of payments related to a previously established transaction.

The contact system 200 may further include a contact manager 220 to manage one or more actions 221 to be completed for a pool of available accounts. Generally stated, an “action” 221 constitutes any means of attempt to contact, notify, inform, or otherwise interact with a person or entity. Examples of actions 221 include, but are not limited to, making an outbound phone call, sending a letter, sending an e-mail message, sending an SMS or MMS message, issuing a Push Notification, or the like. The list of actions may be configurable by a user of the system.

Actions 221 may be configured with additional data related to the execution of the particular action. Such additional data may, but need not, be account agnostic. For example, a letter action may be configured with specific text that is used for the letter regardless of which account or accounts will be sent the letter. Similarly, a phone call action may be configured with outbound caller ID information to display.

The contact system 200 may include a scheduling component 230 that identifies discrete time windows 231 within which actions 221 may occur. These time windows may be preconfigured with specific ranges, configured by the user, or dynamically generated based on data contained in the data platform.

Time windows 231 may include a notion of capacity, constraining the number of possible actions that may be taken in that window. In one embodiment, the capacity in a time window may be configured by the user. In another preferred embodiment, the capacity may be determined based on the available number of human agents available to take a call, and the number of historical actions supported by agents on previous days.

The specific start and end times of any particular window 231 may be preprogrammed with a reasonable value, such as each window 231 representing one hour of each day. Alternatively, the times may be derived from the historical action data using statistical or machine learning methods as described below.

Each time window 231 may have the option of excluding certain actions based on the account, the action, or both the account and the action. For example, time windows 231 may exclude phone calls to accounts prior to 8 am, adjusting for the time zone on the individual account.

The contact system 200 may include a prioritization component 240 to create a prioritized listing 241 of accounts, contact methods, or both accounts and contact methods based on a configurable goal. The system 200 may produce one or more predictive metrics that represent the value of future outcomes. Additionally, each account or group of accounts may be configured with a priority tier that indicates that some actions should be prioritized above others.

In one preferred embodiment, account prioritization is based on an estimate of future value, resulting from an available action, if made during each identified time window hit from the scheduling component 230.

In another preferred embodiment, account prioritization is based on the probability of an action (e.g., a phone call) reaching the intended individual if made during each of the available time windows from the scheduling component 230.

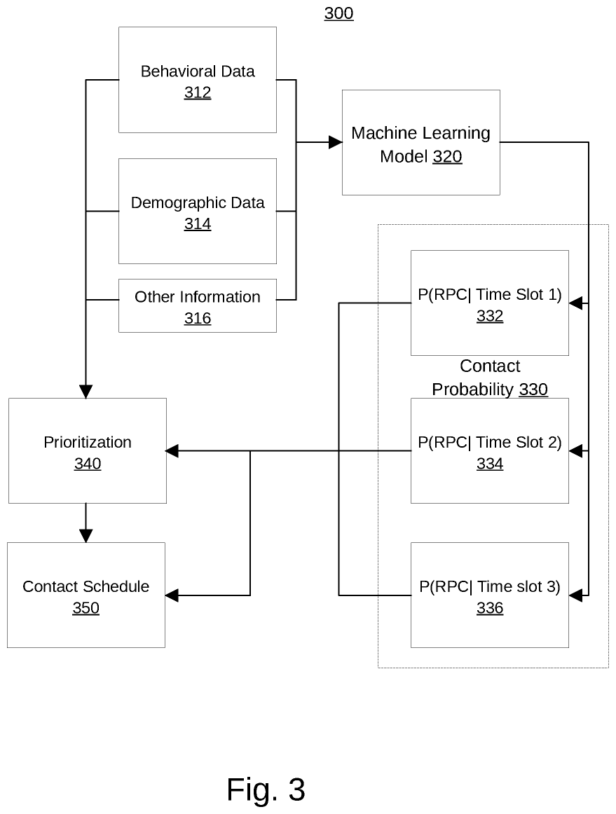

The predictive metrics may be determined using any one or more of a variety of methods. In one preferred embodiment, a machine learning model may predict the probability of a successful outcome on an account, by using the previous outcomes for other similar accounts. One such embodiment is illustrated in FIG. 3 and described below. Other embodiments will be apparent to those skilled in the art.

The contact system 200 may further include a contact method manger 250 that identifies and manages which accounts, individuals, phone numbers, or contact methods are eligible to receive each form of action. This information may be uploaded, configured by the user, or be generated internally by the system 200. In one preferred embodiment, some eligibilities are identified using a rules engine that combines profile data and historical interaction data, with regulatory restrictions and business rules.

The contact system 200 may include a predictive mechanism 260 to generate an estimated likelihood that a future action results in a successful outcome with a primary consideration being a time of day the action occurs. The generated likelihood could be in the form of a probability estimate, ranking, classification or any other metric that can be used to produce a comparison between taking an action at multiple different times.

There are many possibilities for producing the prediction at each time interval. In one preferred embodiment, a separate machine learning model is trained for each time interval, trained on the independent call history for many accounts.

Each individual account or contact record may be expanded into several training rows, each representing a call previously made (the “call depth”). A record with ten calls could be expanded into ten possible snapshots for training. For each call depth snapshot, the snapshot data may include, for example, the number of attempted actions, number of successful actions until this point, and demographic information about the caller or account.

In one preferred embodiment, snapshots may be grouped by the time interval in which the next call attempt should occur. For example, snapshots with call depth of, say, 10 could be sorted into different groups depending on what time of day call depth 11 occurs.

Separate machine learning models may be trained for each group, so that a model is formed to predict the probability of success at each time interval. The input to the model is the state of the snapshots at call depth N, and the output is the actual outcome of snapshot at depth N+1.

In a preferred embodiment, the time interval represents one or more intervals during a single day. Many other time intervals may be formed such as, without limitation, the week of the month, the week of the year, the year, the season, weekdays versus weekends, holidays versus non-holidays, recurring events, or the like.

The contact system 200 may include a schedule recommendation component 270 that identifies, and produces as an output, a “best” time of day for each action to occur. Alternatively, the schedule recommendation component 270 may identify a preferred sequence for actions to occur. For the purpose of this disclosure, the term “best” does not necessarily mean an absolute greatest calculable probability. Rather, the term “best” refers to an option that substantially maximizes, given the known data, a likelihood of actual contact.

The recommendation may attempt to maximize the total aggregate utility value of the scheduled events. This recommendation may take into consideration the estimated value of a successful action, such as may be generated by the prioritization component 240, as well as the likelihood of a successful action, such as may be generated by the predictive mechanism 260.

The recommendation may produce an allocation of events that is optimal after including operational constraints. These constraints may be the ones described in conjunction with the contact method manager 250, or may be added via additional configuration, internal rules, or heuristics.

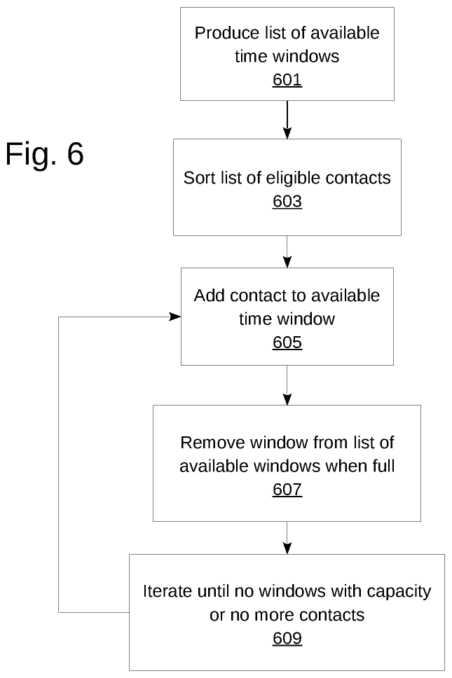

In one embodiment, a “greedy” scheduling approach may be used. One illustrative greedy scheduling approach that may be used in embodiments of this disclosure is illustrated in FIG. 6.

Turning briefly to FIG. 6, an illustrative process 600 implementing a greedy scheduling approach performs steps including:

At step 601, producing a list of available time windows, each with an estimated capacity value.

At step 603, sorting the list of eligible contacts (accounts, individuals, phone numbers, etc.) from the highest expected value to the lowest.

At step 605, for each eligible contact, adding the contact to one of the available time windows, reducing its total remaining capacity by 1.

At step 607, when an available time window has no remaining capacity, removing it from the list of available time windows.

At step 609, continuing the process 600 until no time windows have remaining capacity, or until no unscheduled contacts remain.

Returning now to FIG. 2, in one embodiment the schedule may be pre-computed. For example, the schedule may be computed each day, prior to the start time of the first available time window. Alternatively, scheduled contacts may be computed shortly before the beginning of each time window, taking into consideration new data or constraints that were created during previous time windows.

In one embodiment, an attempted but unsuccessful call placed to an account may result in a second attempt later in the day; however, the second attempt would not occur if the first attempt were successful.

It should be noted that as the duration of each time window approaches zero, the calculation of scheduled actions begins to act as a “real-time” scheduler.

The scheduler may produce a recommendation that optimizes the result over a specified time span, or the composite of many future time spans. In one embodiment, the scheduler may produce a schedule optimized over the course of the time intervals in one day. In another, preferred embodiment, the scheduler may produce a schedule optimized over an indefinite number of days in the future, which is constantly refined by new actions, as described above.

The contact system 200 may include an exporter component 280 that is responsible for formatting the schedule output and exporting it to a destination system. The export format may be defined by the system, via configuration, or match an existing interoperability format. In one preferred embodiment, the export file matches an API by an external vendor responsible for executing outbound communication activities.

In various embodiments, the exporter component 280 may either “push” scheduled actions to a destination, or it may allow a consuming system to “pull” a list of actions from the exporter component 280.

The exporter component 280 may operate using either a batch or streaming mechanism. In one typical embodiment, the exporter sends scheduling information once per day, or once per hour. In another, preferred embodiment, the exporter sends one or more scheduled actions to a vendor upon the vendor's request.

FIG. 3 is a flow diagram 300 generally illustrating another process to obtain a contact schedule 340 in accordance with the teachings of the present disclosure. In various embodiments, data processing may be performed by a single processing device 110, or it may be distributed over more than one processing device 110. As will be described in greater detail below, account information for first accounts and a trained machine learning model 320 may be used to generate a contact schedule 340 for contacting first accounts.

The account information may initially include behavioral data 312, demographic data 314 and other information 316. The behavioral data 312 may include a contact attempts log. The contact attempts log may include timing information such as a time stamp, as well as results of contact attempts such as if the call disconnected, if the desired party (real person) was reached, and if a voicemail was left. The demographic data 314 may include location information (such as a zip-code, phone area code, state, and census region) and location demographics information (such as total number of households in the zip-code state or census region, total number of households with children, median children per household, government employment statistics, median years of education, median income, percent of population by age group, parent of people who work evenings, and percent of people who commute 30+ minutes). The other information 316 may include if a letter, text message or other communication has been sent to the first contact, an account age of the first account, an account value, and other information related to the first account.

In various embodiments, the account value may be computed in various ways, as will become apparent to those skilled in the art upon a reading of this disclosure. For instance, in one preferred embodiment, the account value may be calculated using a model that estimates the future expected value of the account. In another preferred embodiment, the account value may be calculated using a model that estimates the marginal value of taking an action in each time slot (e.g., what is the incremental value of making a call right now, rather than the total future value). In still another preferred embodiment, the account value may be calculated using a policy that includes the execution of rules that can be either user-defined or the result of a computation. In yet another preferred embodiment, the account value may be calculated using a third-party source for the account value, such as a score from an external vendor. These and other methods will be apparent to those skilled in the art from the instant disclosure.

The behavioral data 312, demographic data 314 and other information 316 may be fed into a trained machine learning model 320 to generate a contact probability 330 for each first account for each time slot. The trained machine learning model 320 may use a snapshot of the last contact attempts from the contact attempt log (10 attempts, for example) as input into the trained machine learning model as well as the demographic data and other information, if a number of first results for previous contact attempts for a first account is equal to or above a threshold value (for example 10). If an insufficient number of contact attempts have been made (i.e. if a number of first results for previous contact attempts for a first account is below a threshold value), the trained machine learning model may use only the demographic data and other information. In one example embodiment, there may be three time slots during a day and a contact probability 330 may be generated for each timeslot for each account (e.g. probability of real person contact in time slot 1 (P(RPC| Time Slot 1)) 332, P(RPC| Time Slot 2) 334, and P(RPC| Time Slot 3) 336). Time slot 1 may be a morning, time slot 2 may be afternoon, and timeslot 3 may be evening. However, example embodiments are not limited to three time slots, any number of time slots for any time periods may be used.

The contact probability 330 is added to the account information for each first account. The account information, including an account value of each first account may be used to generate an account prioritization 340. The prioritization 340 may take several forms. In some example embodiments the prioritization 340 may be a list ordering of the first accounts. In another example, the prioritization 360 may be a numerical value assigned to each first account.

In one example embodiment, the prioritization 340 may be based on the account value, such that accounts with greater value are prioritized. In another example embodiment, the prioritization 340 may be based on a weighted value of the account based on an account value 318 and a probability of recovery on the account or contact probability 330. In yet another example embodiment, the prioritization 340 may be based on the account age of the first accounts. Further, the prioritization 340 may be based on a combination of factors.

The prioritization 340 and contact probability 330 for each time slot may be used to generate a contact schedule 350. Due to limited resources, a limited number of accounts may be assigned to each time slot, i.e. each time slot may only have room for a given number of assigned first accounts. The contact schedule 350 may be generated by using the prioritization 340 to assign the highest priority first accounts to the time slot with the highest probability of contact as long as there is available room for the first account in the time slot with the highest probability. If the time slot with the highest probability does not have room for the first account, then the first account will be scheduled into the time slot with the highest probability with room available. This process may continue until all of the time slots are full or until there are no more first accounts to be scheduled.

As another example, the first accounts may be scheduled in order to maximize the total contact probability 330 of the first accounts. Accordingly, a first account even with a high priority value may not be scheduled into the time slot which has the highest contact probability 330 if placing it in another time slot to make room for another first contact would improve the overall contact probability for all of the first accounts. As yet another example, the contact schedule 350 may be generated to minimize the number of first accounts which have a contact probability 330 below a threshold level. Any one or more of the above discussed operations with relation to generating the contact schedule 350 may be performed by one or more processing devices 110. As described above, the account information used by the machine learning model and the account information used to determine the prioritization 340 may include different sets of information. Accordingly, the contact probability 330 may be determined based on a first set of account information and the prioritization 340 may be determined based on a second set of account information.

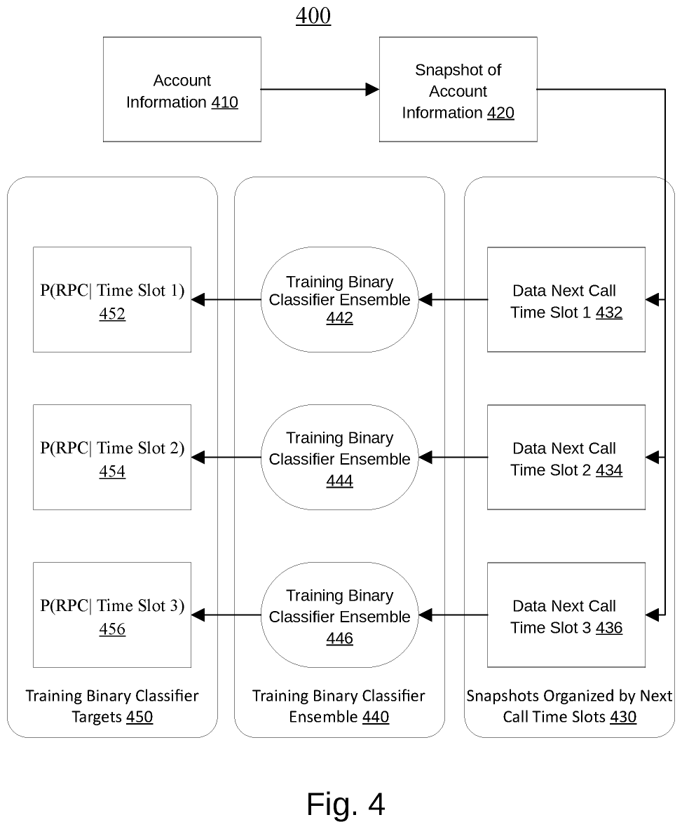

FIG. 4 is a flow diagram 400 generally illustrating another process to obtain a trained machine learning model 320 in accordance with the teachings of the present disclosure. Account information 410 (including behavioral data 312, demographic data 314, and other information 316 as described above) for accounts (training accounts and/or first accounts) may be processed to obtain snapshots of the account information 420. The accounts include the account information.

The snapshots of the account information 420 may be a plurality of contact attempts in the contact attempts log from the behavioral data for the account along with the demographic data and other information at the time of the plurality of contact attempts (for example, an account age in the snapshot may be different that the current age of the account). In an example, the snapshot may include eleven consecutive contact attempts taken randomly from the contact attempt log for the account, ten being used for data in the machine learning model and the last one (next call) being the result used to train the binary classifier ensemble. The snapshots may be organized by the next call time slot 430. For example, if the eleventh call log is for a call made in the first time slot of a day then the data will be organized as data next call time slot 1 432, if the eleventh call log is for a call made in the second time slot of a day then the data will be organized as data next call time slot 2 434, and if the eleventh call log is for a call made in the third time slot of a day then the data will be organized as data next call time slot 3 436.

The snapshots organized by next call time slots 430 may then be used in training binary classifier ensembles 442, 444, 446 of a supervised machine learning model to obtain training binary classifier targets 450. The training binary ensembles 442, 444, 446 are sets of variables which are trained based on the known input (first ten contact attempt log entries) and output (eleventh contact attempt log entry). The training binary classifier targets 450 are sample results of the trained machine learning model. The machine learning model thus may be a combination of logistic regressive models (one for each time slot). In other embodiments, other supervised machine learning models may also be used.

The data next call time slot 1 432 is used in training binary classifier ensemble 442, to produce P(RPC| Time Slot 1) 452, the data next call time slot 2 434 is used in training binary classifier ensemble 444, to produce P(RPC| Time Slot 2) 454, and the data next call time slot 3 436 is used in training binary classifier ensemble 446, to produce P(RPC| Time Slot 3) 456. All of the above discussed operations with relation to training the machine learning model may be performed by one or more processing devices 110.

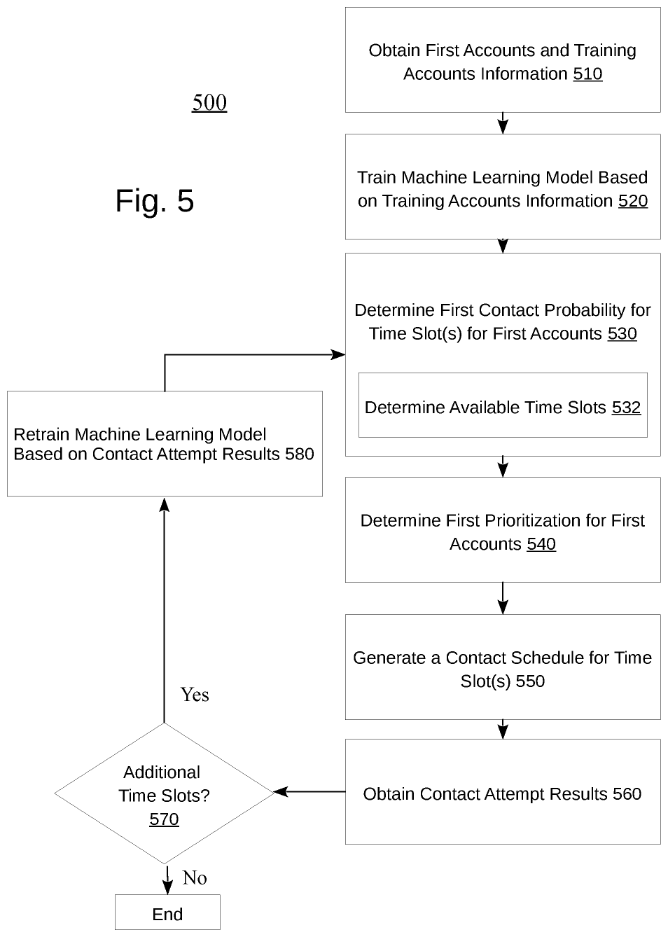

FIG. 5 is a flow diagram 500 illustrating a method of generating a contact schedule 350 and contacting first accounts in accordance with the teachings of the present disclosure. At 510, the processing device 510 may obtain first accounts information and training accounts information. The first accounts are current accounts to be assigned to the contact schedule 350 in order to contact a real person (account responsible) associated with the account. The training accounts are accounts used to train the machine learning model. At 520, the machine learning model may be trained based on the training accounts information. The training may be done using the operations discussed above with relation to FIG. 4.

At 530, the trained machine learning model may be used to determine first contact probability 330 for each time slot for each of the first accounts. The probability for each time slot for each of the first accounts may be determined using the operation discussed above with relation to FIG. 3. Restated, at 530, the processing device 110 may determine a first contact probability 330 for each of a plurality of time slots for each of a plurality of first accounts based on a first set of account information and first contact attempt logs for each of the plurality of first accounts. The first contact probability 330 is determined using a trained machine learning model, where the trained machine learning model 320 is trained based on training accounts.

As part of 530, at 532, the processing device 110 may determine which time slots are eligible for contact attempts for the first accounts. Many jurisdictions restrict the hours in which unsolicited calls may be made. Accordingly, in order to comply with regulations, the location of the account responsible may be used to determine during what time slots an account is eligible to be contacted.

At 540, a first prioritization 340 for the first accounts may be determined. The prioritization 340 may be determined using the operation discussed above with relation to FIG. 3. At 550, a contact schedule 350 for one or more time slots is generated. The contact schedule 350 may be determined using the operation discussed above with relation to FIG. 3. In some example embodiments, all of the time slots for a given period (such as a day or a week) may be generated at once. In other example embodiments, only a contact schedule 350 for one or more proximate time slots is generated. Restated, the processing device 110 may generate a contact schedule 350 based on the first contact probability 330 for each of the plurality of time slots for each of the plurality of first accounts and the first prioritization 340 for each of the plurality of first accounts, where the contact schedule 350 includes the time slots and the plurality of first accounts are each assigned to one of the time slots. Alternatively, the processing device may generate a contact schedule 350 for a proximate (first) time slot of the plurality of time slots based on the first contact probability 330 for each of the plurality of time slots for each of the plurality of accounts and the prioritization 340 for the plurality of accounts

At 560, and contact attempt results from contact attempts are obtained by the processing device and logged into the contact attempt log. The contact attempts may be made by people operating telephones or other communication devices. At 570, a determination is made if a contact schedule 350 is needed for additional time slots. In the case where all of the contact schedules 350 for the time slots for the given time period are generated, the answer will always be ‘no’ and this operation may be skipped. In the case, where a contact schedule 350 is generated for only one or more proximate time slots, the determination may be made. If there are more additional time slots (‘yes’) the processing device 110 proceeds to 580, if there are no more additional time slots (‘no’) the method ends.

At 580, the trained machine learning model 320 may be retrained using the additional input from the contact attempt results obtained at 560. The trained machine learning model 320 may be retrained using the account information (including the contact attempt results) in the same way as the trained machine learning model 320 was trained previously. Then, the processing device 110 may return to 530 and determine (or update) the first contact probability 330 for the remaining time slots and the remaining first accounts. Then at 540, prioritization 340 may be updated (if the first contact probability 330 is being used to determine the prioritization 340), and at 550 the contact schedule 350 for the next time slot may be generated based on the updated first contact probability 330 and prioritization 340. In one example embodiment the remaining first accounts may include all accounts which did not have a successful real person contact in a previous time slot. In another example embodiment the remaining first accounts may include only first accounts that were not scheduled to be contacted in a previous time slot.

Other embodiments may include combinations and sub-combinations of features described above or shown in the Figure s, including, for example, embodiments that are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

In the foregoing description, numerous details have been set forth in order to provide a sufficient understanding of the described embodiments. In other instances, well-known features have been omitted or simplified to not unnecessarily obscure the description.

A person skilled in the art in view of this description will be able to practice the disclosed invention. The specific embodiments disclosed and illustrated herein are not to be considered in a limiting sense. Indeed, it should be readily apparent to those skilled in the art that what is described herein may be modified in numerous ways. Such ways can include equivalents to what is described herein. In addition, the invention may be practiced in combination with other systems. The following claims define certain combinations and subcombinations of elements, features, steps, and/or functions, which are regarded as novel and non-obvious. Additional claims for other combinations and subcombinations may be presented in this or a related document.

What is claimed is:

1. A system, comprising:
a memory storing computer readable instructions; and
a processor configured to execute the computer readable instructions to:
determine a first contact probability for each of a plurality of time slots for each of a plurality of first accounts based on a first set of account information and first contact attempt logs for each of the plurality of first accounts, wherein the first contact probability is determined using a trained machine learning model, wherein the trained machine learning model is trained based on training accounts;
determine a first prioritization for each of a plurality of first accounts based on a second set of account information;
generate a contact schedule based on the first contact probability for each of the plurality of time slots for each of the plurality of first accounts and the first prioritization for each of the plurality of first accounts, wherein the contact schedule includes the time slots and wherein the plurality of first accounts are each assigned to one of the time slots.

2. The system recited in claim 1, wherein the first set of account information includes first location information and a first contact attempt log including first results for previous contact attempts for respective first accounts.

3. The system recited in claim 2, wherein each of the training accounts includes training location information and a training contact attempt log including training results for contact attempts for respective training accounts, and further wherein the trained machine learning model is trained based on snapshots of the training results for the contact attempts and training location information.

4. The system recited in claim 3, wherein
if a number of first results for previous contact attempts for a first account is equal to or above a threshold value, the first contact probability for the first account is determined based on the first location information and a snapshot of the results for the contact attempts, and
if the number of first results for the previous contact attempts for the first account is below the threshold value, the first contact probability for the first account is determined based on the first location information.

5. The system recited in claim 1, wherein the second set of account information includes an account age for each of the first accounts and the first prioritization is generated based on the account age.

6. The system recited in claim 1, wherein the first set of account information includes an account value and the first prioritization is generated based on the account value.

7. The system recited in claim 6, wherein the second set of account information includes the first contact probability for each of a plurality of time slots and the first prioritization is generated based on the first contact probability.

8. The system recited in claim 1, wherein the processor is further configured to execute the computer readable instructions to determine eligible time slots among the plurality of time slots for each of the plurality of first accounts.

9. The system recited in claim 8, wherein the contact schedule is further generated based on the determined eligible time slots for each of the plurality of first accounts.

10. A system, comprising:
a memory storing computer readable instructions; and
a processor configured to execute the computer readable instructions to perform the following:
determine a first contact probability for each of a plurality of time slots for each of a plurality of first accounts based on a first set of account information and first contact attempt logs for each of the plurality of first accounts, wherein the first contact probability is determined using a trained machine learning model, wherein the trained machine learning model is trained based on training accounts;
determine a first prioritization for each of a plurality of first accounts based on a second set of account information;
generate a contact schedule for a first time slot of the plurality of time slots based on the first contact probability for each of the plurality of time slots for each of the plurality of accounts and the first prioritization for the plurality of accounts;
update the first contact probability for the remaining time slots based on call attempts in the first time slot;
generate a contact schedule for a second time slot of the plurality of time slots based on the updated first contact probability for each remaining timeslot of the plurality of time slots for each of the plurality of accounts and the first prioritization for the plurality of accounts.

11. The system recited in claim 10, wherein the first set of account information includes first location information and a first contact attempt log including first results for previous contact attempts for respective first accounts.

12. The system recited in claim 11, wherein each of the training accounts includes training location information and a training contact attempt log including training results for contact attempts for respective training accounts, wherein the trained machine learning model is trained based on snapshots of the training results for the contact attempts and training location information.

13. The system recited in claim 12, wherein
if a number of first results for previous contact attempts for a first account is equal to or above a threshold value, the first contact probability for the first account is determined based on the first location information and a snapshot of the results for the contact attempts, and
if the number of first results for the previous contact attempts for the first account is below the threshold value, the first contact probability for the first account is determined based on the first location information.

14. The system recited in claim 10, wherein the second set of account information includes an account age for each of the first accounts and the first prioritization is generated based on the account age.

15. The system recited in claim 10, wherein the first set of account information includes an account value and the first prioritization is generated based on the account value.

16. The system recited in claim 15, wherein the second set of account information includes the first contact probability for each of a plurality of time slots and the first prioritization is generated based on the first contact probability.

17. The system recited in claim 10, wherein the processor is further configured to execute the computer readable instructions to determine eligible time slots among the plurality of time slots for each of the plurality of first accounts.

18. The system recited in claim 17, wherein the contact schedule is further generated based on the determined eligible time slots for each of the plurality of first accounts.
